(19) United States
(12) Patent Application Publication
(10) Pub. No.: US 2010/0102989 A1
(43) Pub. Date: Apr. 29, 2010

(54) METHOD FOR PROVIDING MOBILE SIGN POST SERVICE AND SYSTEM THEREOF

(75) Inventor: Sang Yong Lee, Seoul (KR)

Correspondence Address: AKERMAN SENTERFITT, P.O. BOX 3188, WEST PALM BEACH, FL, 33402-3188, US

(73) Assignee: Thinkware Systems Corporation, Seoul (KR)

(21) Appl. No.: 12/530,864

(22) PCT Filed: Dec. 10, 2007
(86) PCT No.: PCT/KR07/06400

§ 371 Date: Sep. 11, 2009

(30) Foreign Application Priority Data
Mar. 16, 2007 (KR) 10-2007-0026296

(51) Int. Cl. G08G 1/095

(52) U.S. Cl. 340/908

(57) ABSTRACT

The present invention relates to a method and system for providing geographic information which provides guidance about a route to a destination desired by a user. The method of providing geographic information, the method including: providing guidance about a route to a destination set by a user; reading a plurality of zoomed-in scenes of a target access road to enter when approaching an intersection including a plurality of access roads on the route; and continuously providing the read zoomed-in scenes and providing guidance about a route to the target access road.

### TECHNICAL FIELD

The present invention relates to a mobile sign service method and system, and more particularly, to a mobile sign service method and system which generates a sign image including traffic information about an intersection corresponding to a location of a user and provides a user terminal with the sign image.

### BACKGROUND ART

A mobile communication terminal provides traffic information service of an area that a user desires to know, based on data transmission via wireless Internet.

However, a method of providing traffic information using a mobile communication terminal in a conventional art may not accurately ascertain a traffic condition around a user. That is, the method of providing traffic information in a conventional art may not precisely recognize speed information for each road with respect to each direction of an intersection where a user is located.

### DISCLOSURE OF INVENTION

### Technical Goals

The present invention provides a mobile sign service method and system which generates a sign image including traffic information about an intersection corresponding to a location of a user, and provides the sign image to a mobile communication terminal of the user.

The present invention also provides a mobile sign service method and system which provides a mobile communication terminal of a user with a traffic sign with respect to a road where the user drives and traffic information.

The present invention also provides a mobile sign service method and system which simultaneously displays a nearby intersection corresponding to a location of a user when connecting to a service, and provides information about a previous intersection or subsequent intersection according to a request from the user.

The present invention also provides a mobile sign service method and system which generates an intersection of each area as a simplified image map, displays traffic information of a corresponding direction in the image map, and thereby may enable a user to easily recognize speed information for each road with respect to a surrounding traffic condition.

The present invention also provides a mobile sign service method and system which configures information about each direction of an intersection to be the same as a real traffic sign, and thereby may enable a user to be provided with traffic information more easily.

### Technical Solutions

According to an aspect of the present invention, there is provided a mobile sign service method, including: receiving a request for a mobile sign service from a user terminal; retrieving a location of the user terminal; generating a sign image using traffic information for each intersection, the traffic information corresponding to the location of the user terminal; and providing the user terminal with the sign image.

According to another aspect of the present invention, there is provided a mobile sign service system, including: a location retrieval unit retrieving a location of a user terminal based on a mobile sign service; a traffic information providing unit providing traffic information for each intersection, the traffic information corresponding to the location of the user terminal; a sign image generation unit generating a sign image using the traffic information for each intersection; and a transmission unit transmitting the sign image to the user terminal.

### BRIEF DESCRIPTION OF DRAWINGS

FIG. 1 is a block diagram illustrating a configuration of a mobile sign service system according to an exemplary embodiment of the present invention;

FIG. 2 is a diagram illustrating an example of a mobile sign service according to an exemplary embodiment of the present invention;

FIG. 3 is a diagram illustrating another example of a mobile sign service according to an exemplary embodiment of the present invention;

FIG. 4 is a diagram illustrating a relationship between a keypad number and driving direction according to an exemplary embodiment of the present invention; and

FIG. 5 is a flowchart illustrating a mobile sign service method according to another exemplary embodiment of the present invention.

### BEST MODE FOR CARRYING OUT THE INVENTION

Hereinafter, embodiments of the present invention are described in detail by referring to the figures.

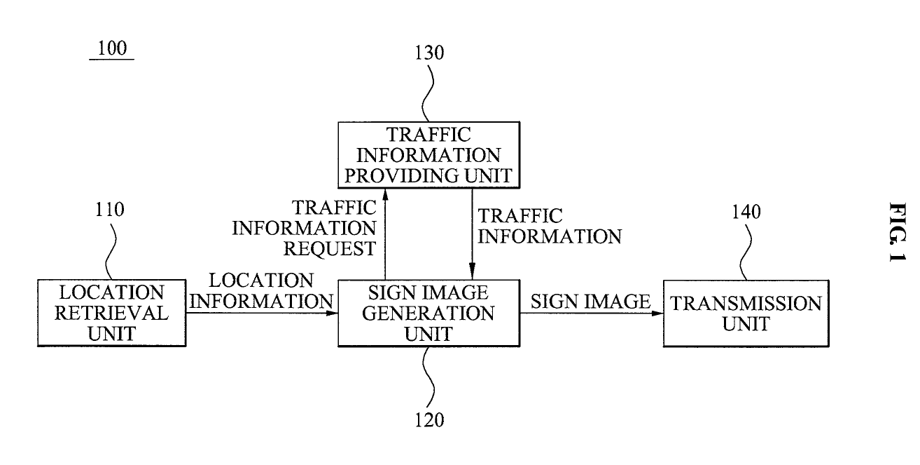

FIG. 1 is a block diagram illustrating a configuration of a mobile sign service system 100 according to an exemplary embodiment of the present invention.

Referring to FIG. 1, the mobile sign service system 100 includes a location retrieval unit 110, sign image generation unit 120, traffic information providing unit 130, and transmission unit 140. The mobile sign service system 100 retrieves a location of a user that requests a mobile sign service, generates a sign image based on traffic information corresponding to the location of the user, and provides the sign image to a mobile communication terminal of the user.

The location retrieval unit 110 retrieves the location of the user based on the mobile sign service. That is, when receiving a request for the mobile sign service from the mobile communication terminal of the user, the location retrieval unit 110 retrieves a location of the mobile communication terminal. The user selects the mobile sign service according to a wireless Internet connection service menu through the mobile communication terminal, or inputs a particular pre-registered number, or through a wireless Internet connection menu, and thereby may request the mobile sign service. The wireless Internet connection service menu is provided by a mobile communication company where the user is subscribed. Also, the location retrieval unit 110 transmits location information of the user to the sign image generation unit 120. For example, when ‘Ulziro #2’ is retrieved as the location of the mobile communication terminal, the location retrieval unit 110 transmits the location information of the user, ‘Ulziro #2’, to the sign image generation unit 120.

The sign image generation unit 120 receives the location information of the user from the location retrieval unit 110, and requests the traffic information providing unit 130 for traffic information corresponding to the location information. For example, when the location information of the user is ‘Ulziro #2’, the sign image generation unit 120 requests the traffic information providing unit 130 for traffic information about an intersection of ‘Ulziro #2’ corresponding to the location information of the user.

The traffic information providing unit 130 provides traffic information for each intersection. The traffic information corresponds to the location of the user. That is, the traffic information providing unit 130 receives the request for the traffic information corresponding to the location of the user from the sign image generation unit 120, and transmits the traffic information for each intersection to the sign image generation unit 120. The traffic information may be speed information for each road. For example, when the location information of the user is ‘Ulziro #2’, the traffic information providing unit 130 may transmit, to the sign image generation unit 120, traffic information about ‘Ulziro’, ‘Tege #2’, ‘Cheogge #2’, and ‘Ulziro #3’ around ‘Ulziro #2’ as an intersection. For example, when the traffic information is the speed information for each road, the traffic information providing unit 130 may transmit, to the sign image generation unit 120, driving speed information about a road to ‘Ulziro’, driving speed information about a road to ‘Tege #2’, driving speed information about a road to ‘Cheogge #2’, and driving speed information about a road to ‘Ulziro #3’ as speed information for each road of an intersection of ‘Ulziro #2’.

The sign image generation unit 120 generates a sign image using the traffic information for each intersection. Specifically, the sign image generation unit 120 receives the traffic information corresponding to the location of the user from the traffic information providing unit 130, and generates the sign image to enable the user to recognize the traffic information for each intersection more easily. The sign image includes the traffic information for each intersection.

The sign image generation unit 120 generates a lane of an intersection of each area as a simplified image map, and generates the sign image displaying traffic information about each direction of the intersection on the image map. For example, the sign image generation unit 120 may generate information about the lane of the intersection of each area as a simple image map including three to five lanes, and generate the sign image displaying traffic information of each direction of the intersection in the image map.

The sign image generation unit 120 configures information about each direction of the intersection to be the same as a real traffic sign, based on the traffic information for each intersection, and generates the sign image.

The sign image generation unit 120 matches a driving direction with respect to the intersection with a keypad direction of the mobile communication terminal of the user, and generates the sign image based on the traffic information for each intersection.

The transmission unit 140 transmits the sign image to the mobile communication terminal of the user. For example, the transmission unit 140 may be embodied as a Wireless Application Protocol (WAP) server. The transmission unit 140 may transmit the sign image to the mobile communication terminal connected via the WAP server.

Accordingly, the mobile sign service system generates a mobile sign, that is, the sign image, provides the mobile sign to the mobile communication terminal of the user, and thereby may enable the user to easily recognize traffic condition and traffic sign through the mobile communication terminal. The mobile sign includes the traffic information corresponding to the location of the user.

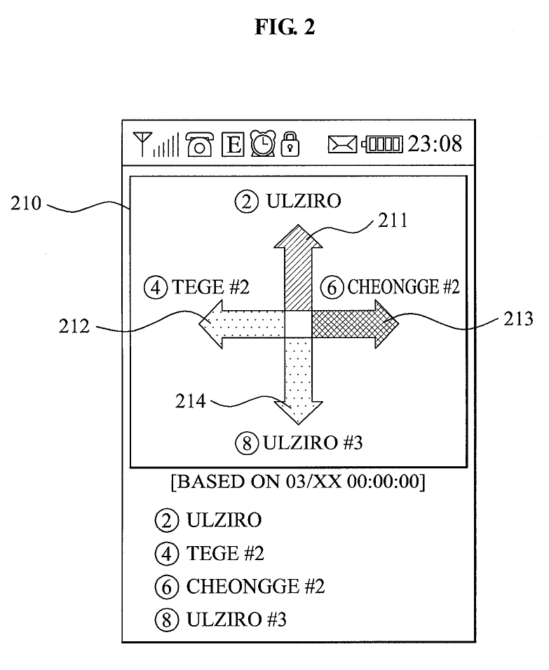

FIG. 2 is a diagram illustrating an example of a mobile sign service according to an exemplary embodiment of the present invention.

Referring to FIG. 2, a sign image 210 is an example of a sign image of an intersection of ‘Ulziro #2, a sign 211 is an example of a sign including traffic information about ‘Ulziro’, and a sign 212 is an example of a sign including traffic information about ‘Tege #2’. Also, a sign 213 is an example of a sign including traffic information about ‘Cheongge #2’, and a sign 214 is an example of a sign including traffic information about ‘Ulziro #3’.

For example, the sign image 210 may indicate that a section speed of a road corresponding to ‘Cheongge #2’ is the slowest, a section speed of a road corresponding to ‘Ulziro’ is faster than a section speed of a road corresponding to ‘Cheongge #2’, and a section speed of a road corresponding to ‘Tege #2’ and ‘Ulziro #3’ is the fastest.

Also, when a user is going straight to ‘Ulziro’ from the intersection of ‘Ulziro #2’, in the sign image 210, \textcircled{2} indicates a road to ‘Ulziro’ when the user goes straight, \textcircled{4} indicates a road to ‘Tege #2’ when the user turns left, \textcircled{6} indicates a road to ‘Cheongge #2’ when the user turns right, and \textcircled{8} indicates a road to ‘Ulziro #3’ when the user drives straight back.

As described above, according to an exemplary embodiment of the present invention, when traffic information for each intersection is a section speed, a sign image may be provided to visually distinguish roads based on a driving direction and section speed for each road.

According to an exemplary embodiment of the present invention, the sign image including the traffic information for each intersection is provided, and thus the user may easily recognize a traffic condition of a road where the user desires to know or road where the user is located. The traffic information for each intersection corresponds to a location of the user.

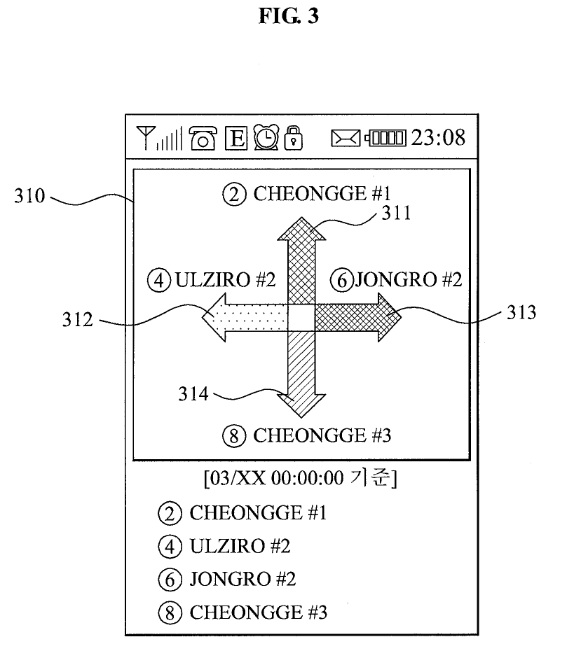

FIG. 3 is a diagram illustrating another example of a mobile sign service according to an exemplary embodiment of the present invention.

Referring to FIG. 3, a sign image 310 is an example of a sign image of an intersection of ‘Cheongge #2’, a sign 311 is an example of a sign including traffic information about ‘Cheongge #1’, and a sign 312 is an example of a sign including traffic information about ‘Ulziro #2’. Also, a sign 313 is an example of a sign including traffic information about ‘Jongro #2’, and a sign 314 is an example of a sign including traffic information about ‘Cheongge #3’.

For example, the sign image 310 may indicate that a section speed of a road corresponding to ‘Cheongge #1’ and ‘Jongro #2’ is the slowest, a section speed of a road corresponding to ‘Cheongge #3’ is faster than a section speed of a road corresponding to ‘Cheongge #1’, and a section speed of a road corresponding to ‘Ulziro #2’ is the fastest.

Also, when a user is going straight to ‘Cheongge #1’ from the intersection of ‘Cheongge #2’, in the sign image 310, \textcircled{2} indicates a road to ‘Cheongge #1’ when the user goes straight, \textcircled{4} indicates a road to ‘Ulziro #2’ when the user turns left, \textcircled{6} indicates a road to ‘Jongro #2’ when the user turns right, and \textcircled{8} indicates a road to ‘Cheongge #3’ when the user drives straight back.

As described above, according to an exemplary embodiment of the present invention, when traffic information for each intersection is a section speed, a sign image may be provided to visually distinguish roads based on a driving direction and section speed for each road.

According to an exemplary embodiment of the present invention, the sign image including the traffic information for each intersection is provided, and thus the user may easily recognize a traffic condition of a road where the user desires to know or road where the user is located. The traffic information for each intersection corresponds to a location of the user.

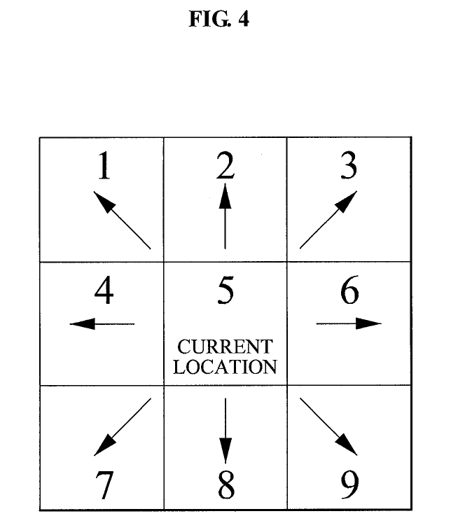

FIG. 4 is a diagram illustrating a relationship between a keypad number and driving direction according to an exemplary embodiment of the present invention.

Referring to FIG. 4, a ‘1’ key indicates that a user drives in a left-hand diagonal direction from a current location, a ‘2’ key indicates that the user goes straight from the current location, a ‘3’ key indicates that the user drives in a right-hand diagonal direction from the current location, a ‘4’ key indicates that the user turns left from the current location, a ‘5’ key indicates that the user drives in the current location, a ‘6’ key indicates that the user turns right from the current location, a ‘7’ key indicates that the user drives in a left-hand diagonal direction in reverse from the current location, a ‘8’ key indicates that the user drives straight back from the current location, and a ‘9’ key indicates that the user drives in a right-hand diagonal direction in reverse from the current location.

As described above, according to an embodiment of the present invention, each driving direction matches with a keypad number direction, and thus the user may easily recognize a driving direction.

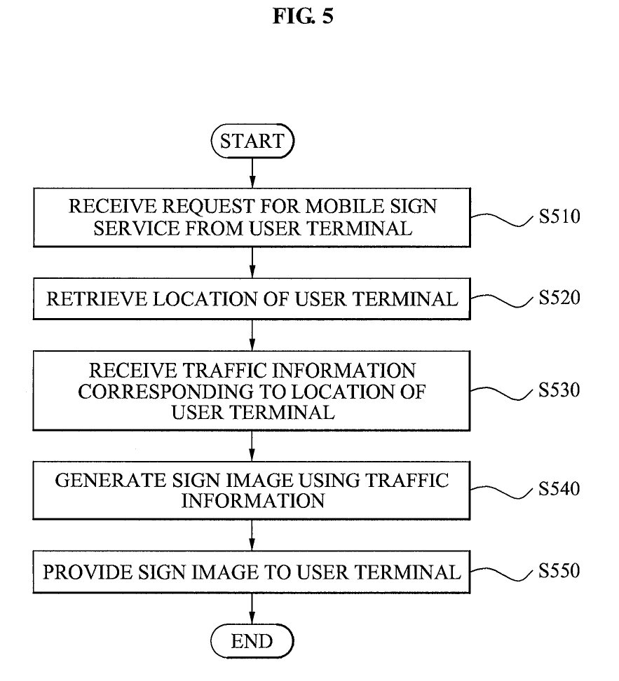

FIG. 5 is a flowchart illustrating a mobile sign service method according to another exemplary embodiment of the present invention.

Referring to FIG. 5, in operation S510, a mobile sign service system receives a request for a mobile sign service from a user terminal. Specifically, in operation S510, the mobile sign service system may receive the request for the mobile sign service from the user terminal based on a menu of the mobile sign service. The user terminal is a terminal of a user that desires to use the mobile sign service.

In operation S520, the mobile sign service system retrieves a location of the user terminal. Specifically, in operation S520, the mobile sign service system may retrieve the location of the user terminal using a base station when the user terminal is a mobile communication terminal.

In operation S530, the mobile sign service system receives traffic information corresponding to the location of the user terminal. Specifically, in operation S530, the mobile sign service system may be provided with the traffic information from a separate traffic information providing system, or be provided with traffic information for each road after collecting the traffic information on its own. The traffic information may include section speed information for each road.

In operation S540, the mobile sign service system generates a sign image using the traffic information corresponding to the location of the user terminal. For example, when the traffic information is the section speed information for each road, the mobile sign service system may generate a sign image of each direction based on a section speed for each intersection as illustrated in FIG. 2 or 3.

Also, in operation S540, the mobile sign service system generates a lane image of an intersection of each area as a simplified image map, and generates the sign image displaying traffic information about each direction of the intersection on the image map. For example, in operation S540, the mobile sign service system may generate information about the lane of the intersection of each area as a simple image map including three to five lanes, and generate the sign image displaying traffic information of each direction of the intersection in the image map.

As described above, the mobile sign service method generates the intersection of each area as the simple image map, displays traffic information about a corresponding direction on the image map, and thereby may enable the user to easily recognize speed information for each road.

Also, in operation S540, the mobile sign service system may configure information about each direction of the intersection to be the same as a real traffic sign, based on the traffic information for each intersection, and generate the sign image.

Also, in operation S540, the mobile sign service system may match a driving direction with respect to the intersection with a keypad direction of the user terminal, as illustrated in FIG. 2 or 3, and generate the sign image based on the section speed information for each intersection.

As described above, the mobile sign service method matches the driving direction with respect to the intersection with the keypad direction of the mobile communication terminal, and thus the user may recognize the driving direction more easily.

In operation S550, the mobile sign service system provides the sign image to the user terminal. Specifically, in operation S550, the mobile sign service system provides the user terminal with a sign image corresponding to a nearby intersection based on a location of the user terminal. In operation S550, the mobile sign service system may provide the user terminal, which requests for the mobile sign service, with the sign image corresponding to the location of the user terminal as illustrated in FIG. 2 or 3 via a WAP connection.

Also, in operation S550, when the mobile sign service is provided to the user terminal, the mobile sign service system may additionally receive a request for a mobile sign service from the user terminal using an intersection number provided together with the sign image. In this instance, the mobile sign service corresponds to a location of a previous intersection or subsequent intersection.

As described above, according to an exemplary embodiment of the present invention, the mobile sign service method generates the mobile sign including the traffic information of the intersection corresponding to the location of the user, provides the mobile sign to the mobile communication terminal of the user, and thereby may enable the user to easily recognize a traffic sign and traffic condition of a road where the user desires to go via the mobile communication terminal.

The above-described embodiment of the present invention may be recorded in computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

According to an exemplary embodiment of the present invention, a mobile sign service method and system generates a sign image including traffic information about an intersection corresponding to a location of a user, and provides the sign image to a mobile communication terminal of the user.

Also, according to an embodiment of the present invention, a mobile sign service method and system provides a mobile communication terminal of a user with a traffic sign with respect to a road where the user drives and traffic information.

Also, according to an embodiment of the present invention, a mobile sign service method and system simultaneously displays a nearby intersection corresponding to a location of a user when connecting to a service, and provides information about a previous intersection or subsequent intersection according to a request from the user.

Also, according to an embodiment of the present invention, a mobile sign service method and system generates an intersection of each area as a simplified image map, displays traffic information of a corresponding direction in the image map, and thereby may enable a user to easily recognize speed information for each road with respect to a surrounding traffic condition.

Also, according to an embodiment of the present invention, a mobile sign service method and system configures information about each direction of an intersection to be the same as a real traffic sign, and thereby may enable a user to be provided with traffic information more easily.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

1. A mobile sign service method, comprising:
receiving a request for a mobile sign service from a user terminal;
retrieving a location of the user terminal;
generating a sign image using traffic information for each intersection, the traffic information corresponding to the location of the user terminal; and
providing the user terminal with the sign image.

2. The mobile sign service method of claim 1, wherein the generating generates a lane of an intersection of each area as a simplified image map, and generates the sign image displaying traffic information about each direction of the intersection on the image map.

3. The mobile sign service method of claim 1, wherein the generating configures information about each direction of an intersection to be the same as a real traffic sign, based on the traffic information for each intersection, and generates the sign image.

4. The mobile sign service method of claim 1, wherein the generating matches a driving direction with respect to an intersection with a keypad direction of the user terminal, and generates the sign image based on section speed information for each intersection.

5. The mobile sign service method of claim 1, wherein the providing provides the user terminal with the sign image corresponding to a nearby intersection based on the location of the user terminal.

6. The mobile sign service method of claim 1, wherein the traffic information includes information about a section speed for each intersection, and the generating generates a sign image of each direction according to the section speed for each intersection.

7. The mobile sign service method of claim 1, further comprising:
receiving a request for a mobile sign service from the user terminal using an intersection number provided together with the sign image, the mobile sign service corresponding to a location of a previous intersection or subsequent intersection.

8. A computer-readable recording medium in a machine, comprising computer instructions causing the machine to:
receive a request for a mobile sign service from a user terminal;
retrieve a location of the user terminal;
generate a sign image using traffic information for each intersection, the traffic information corresponding to the location of the user terminal; and
transmit the sign image to the user terminal.

9. A mobile sign service system, comprising:
a location retrieval unit retrieving a location of a user terminal based on a mobile sign service;
a traffic information providing unit providing traffic information for each intersection, the traffic information corresponding to the location of the user terminal;
a sign image generation unit generating a sign image using the traffic information for each intersection; and
a transmission unit transmitting the sign image to the user terminal.

10. The mobile sign service system of claim 9, wherein the sign image generation unit generates a lane of an intersection of each area as a simplified image map, and generates the sign image displaying traffic information about each direction of the intersection on the image map.

11. The mobile sign service system of claim 9, wherein the sign image generation unit configures information about each direction of an intersection to be the same as a real traffic sign, based on the traffic information for each intersection, and generates the sign image.

12. The mobile sign service system of claim 9, wherein the sign image generation unit matches a driving direction with respect to an intersection with a keypad direction of the user terminal, and generates the sign image based on the traffic information for each intersection.

13. The mobile sign service system of claim 9, wherein the transmission unit transmits, to the user terminal, the sign image corresponding to a nearby intersection based on the location of the user terminal.

14. The mobile sign service system of claim 9, wherein the traffic information includes information about a section speed for each intersection, and the sign image generation unit generates the sign image according to the section speed for each intersection.
